(19) United States
(12) Patent Application Publication
(10) Pub. No.: US 2008/0304850 A1
(43) Pub. Date: Dec. 11, 2008

(54) Variable speed printing device with mains overload prevention

(75) Inventors: Mark A. Groninger, Venlo (NL); Berend J.W. Waarsing, Venlo (NL); Ronald Fabel, Venlo (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V., Venlo (NL)

(21) Appl. No.: 11/785,687

(22) Filed: Apr. 19, 2007

(30) Foreign Application Priority Data
Apr. 21, 2006 (EP) 06112924.3
Aug. 1, 2006 (EP) 06118244.0

(51) Int. Cl. G03G 15/00

(52) U.S. Cl. 399/88

(57) ABSTRACT

An image reproduction device includes a print processing system and a print sheet conveying system that conveys sheets with a continuously variable and dynamically adjustable processing speed. The device lowers the processing speed when the mains connection cannot deliver sufficient power to run at a nominal processing speed and is provided with a current monitor unit for monitoring total electrical current drawn by the device from the mains connection and a control unit connected to the current monitor unit and arranged for dynamically adjusting the processing speed to a lower value when the total electrical current is above a preset maximum value. The control unit regulates the lower processing speed value to make sure that the total electrical current drawn by the device from the mains connection is kept substantially equal to the preset maximum current value until the mains power is again sufficient for running at nominal processing speed.

### CROSS-REFERENCE TO RELATED APPLICATIONS

This nonprovisional application claims priority under 35 U.S.C. § 119(a) on Patent Application Nos. 06112924.3 and 06118244.0, filed in the European Patent Office on Apr. 21, 2006 and Aug. 1, 2006, respectively. The entirety of each of the above-identified applications is incorporated herein by reference.

### BACKGROUND OF THE INVENTION

1. Field of the Invention:

The invention relates to an image reproduction device for document processing. More particularly, the invention relates to a device having a processing system for applying visible marks on image support material, including a heat fusing system and a conveying system for conveying the image support material from an input section to the processing system and from the processing system to an output section. The device takes maximal advantage of the energy available from a mains supply, while limiting power consumption to a safe value.

The invention further relates to a method of controlling the image reproduction device.

2. Description of Background Art:

Generally, devices such as copiers and printers are operated on energy that is drawn from the general power net that is omnipresent in office buildings. The device is connected to the power net by plugging it into a mains wall socket. The power net generally delivers a mains voltage that is standardized, 110 V in the United States of America and 230 V in Europe to give only a few examples. The power that can be drawn from a wall socket or group of wall sockets is limited. The power net is secured by fuses that blow when the current drawn from the net rises higher than a specified value in order to prevent overloading the leads and eventually the power station, which could otherwise easily lead to dangerous situations. Moreover, in several countries or regions, excessive loading of the public power net is prevented by lowering the mains voltage, known as a “brown out”. Therefore, electrical devices must be designed so as not to exceed the limitations of the power net and in general, they are designed to keep a safe margin.

U.S. Pat. No. 4,319,874 discloses an apparatus for copying documents and a method of controlling document processing, that includes a fuser for fixing toner images to copy substrates by passing the substrates between two pressure engaged fuser rolls, one of which is heated. A control for effecting movement of the process members of the apparatus, including the fuser rolls, at two different process speeds is provided such that the members are initially moved at the high speed. The initial speed is so high that the heater in the fuser roll cannot deliver enough heat to keep the fuser rolls at their operating temperature. Therefore, the temperature of the fuser rolls is monitored with a sensor, and when the temperature has reached a preset threshold value, the speed of the moving members is switched to the low value. At the low speed, less heat is taken away, and the temperature can rise again to a safe value.

In the known apparatus, the processing speed is controlled on the basis of the fuser temperature to prevent improper fusing of the toner on the copies. However, the real limitation of electrical processes is power consumption in relation to load limitation of the power net. It would therefore be preferable to relate the operation of the device to a parameter that has a direct relation to the power usage, so that the power usage can be monitored and controlled more directly.

### SUMMARY OF THE INVENTION

Accordingly, it is an object of the invention to provide an apparatus and method for flexibly and smoothly controlling an image reproduction device to avoid exceeding the power usage limit of the electrical power net and yet run as fast as possible.

It is another object of the present invention to provide an apparatus and method for controlling an image reproduction device for reducing the production of the apparatus when the operational conditions require more energy than the power net can deliver, and for increasing the production of the apparatus when the power net can deliver more energy than the apparatus currently uses.

According to a first aspect of the invention, the object is achieved in an image reproduction device for document processing, the device including: a mains power connection that draws electrical power from a power net, said net having a current limitation; a processing system that applies visible marks on image support material, including a toner fusing system; a conveying system that conveys the image support material from an input section to the processing system and from the processing system to an output section, wherein the conveying system is adapted to convey the image support material with a continuously variable and dynamically adjustable processing speed; a current monitor unit that monitors total electrical current drawn by the device from the mains connection; a control unit connected to the current monitor unit and arranged to dynamically adjust the processing speed to a lower value when the total electrical current is above a preset maximum value, said lower processing speed value being such that the total electrical current drawn by the device from the mains connection is substantially equal to the preset maximum current value.

According to a second aspect of the invention the object is achieved with a method of controlling an image reproduction device for document processing, the device being powered by a connection to a mains power outlet having a current limitation and including: a processing system that applies visible marks on image support material, including a toner fusing system; and a conveying system that conveys the image support material from an input section to the processing system and from the processing system to an output section, wherein the conveying system is adapted to convey the image support material with a continuously variable and dynamically adjustable processing speed; the method comprising the steps of: presetting a maximum current value; monitoring total electrical current drawn by the device from the mains connection; and dynamically adjusting the processing speed to a lower value if the total electrical current is above the preset maximum value, said lower processing speed value being such that the total electrical current drawn by the device from the mains connection is substantially equal to the preset maximum current value.

In accordance with the above-described aspects of the invention, when during operation of the device the mains voltage sinks, the current drawn by the device, and especially the heaters of the fuser system, initially increases in order to maintain the performance. However, when the current drawn from the net increases too much, the control unit decreases the process speed, and in reaction, the power usage sinks as well, and the current comes back to its normal value. Preferably, the adjustment of the processing speed is done in an iterative process of small steps, such that after each step the effect is first assessed, before any new step is made. Moreover, in accordance with an important aspect of the invention, the processing speed is gradually adjusted from step to step. In this way, it is possible to change the processing speed while the process is running and sheets of image support material, such as paper sheets, are moving through the device. If the speed would be changed in discrete steps, the sheets would be torn or wrinkled by the sudden and local transport speed changes.

If the total electrical current drawn by the device is or comes below the preset maximum value, the processing speed is again increased. The speed may be increased to either the nominal processing speed value of the device, or to a speed corresponding to the preset current maximum value, if that is still below the nominal processing speed. In this way, maximal advantage is taken of the available mains power.

In a further embodiment, the preset current maximum value is in fact a current value range. In this way, frequent speed changes are prevented.

In yet a further embodiment, the preset maximum value is a pre-programmed function of time. In this way, a temporarily higher acceptable loading of the power net can be taken advantage of.

In another embodiment, the control unit dynamically adjusts the processing speed to a lower value with a preset reaction time that is chosen so as to fit to a cooling down characteristic of the toner fusing system. In this way, use is made of the stored heat in the fuser system to make the speed change more gradual. Of course, the change must be ready before the fuser has cooled down so much as to fix the toner insufficiently.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a digital image reproduction device;

FIG. 2 shows gradually adjusting the processing speed to operational conditions;

FIG. 3 shows an energy control system according to the invention;

FIG. 4 shows a flow chart of a control process for the fuser temperature;

FIG. 5 shows a flow chart of an energy control program according to the invention;

FIG. 5A shows a time-related chart of the values of process variables;

FIG. 6 shows a control structure for a digital image reproduction device;

FIG. 7 shows a position and time diagram for a sheet and an image pattern;

FIG. 8 shows a process for adjusting the processing speed; and

FIG. 9 shows calculation of synchronization times.

### DETAILED DESCRIPTION OF THE PREFERRED EMBODIMENTS

The Figures are diagrammatic and not drawn to scale. In the Figures, elements that correspond to elements already described have the same reference numerals.

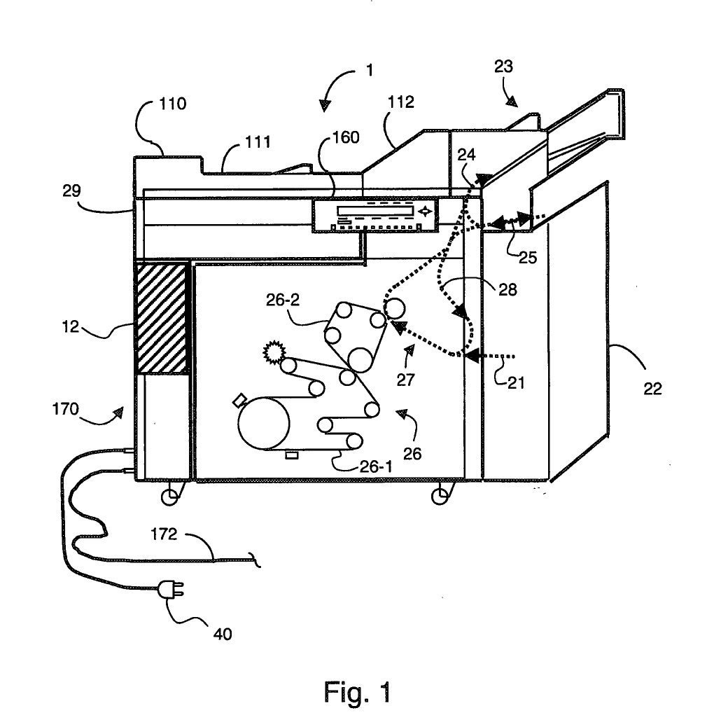

FIG. 1 shows a digital image reproduction device 1, on which the different parts are separately shown in diagram form. The documents to be processed are usually paper sheets, but may also include any other type of sheets for carrying information, e.g. overhead sheets, etc.

The device has an input unit 22 for providing sheets, which may have several trays containing sheets to be processed, and an output unit 23 for receiving processed documents.

The output unit 23 may comprise an output tray, or may be a finisher including sorting, stapling, and further processing of printed sheets.

The device has a printing system 26 which may include an electro-photographic processing section known per se, in which a photoconductive medium 26-1 is charged, exposed via an LED array in accordance with digital image data, and is developed with toner powder. The toner image is then transferred and fixed on an image support in a fuser system 26-2, while the sheet is being conveyed from the input unit to the output unit with a processing speed through a document conveying system 27. The image support is usually a sheet of paper.

Other image forming processes, e.g. a so-called direct imaging process, in which a toner image is directly formed onto a process drum that carries high-resolution electrodes, and then transferred to a fuser system for fixing onto an image support, may also be contemplated.

The document conveying system 27 is for conveying the sheets from an input trajectory 21 at the input unit to an output trajectory 24 at the output unit 23, along printing system 26. The sheet conveying system includes a turning section 25 for turning sheets, and a duplex return trajectory 28, for duplex treatment and/or finisher operations. As such, the printing system 26 and the conveying system 27 having various motors, rollers, guidance elements, belts, etc. are well known in the art of printing devices.

The device also includes a control section, shown diagrammatically by reference numeral 170, and explained in more detail later. A cable 172 may connect the control section 170 via a network interface to a local network. The network may be wired, but may also be partly or completely wireless. The control section 170 includes a control unit 12 arranged for controlling the sheet conveying system 27 and printing system 26. According to the invention, the control unit is arranged for controlling the speed of conveying and processing at a variable rate as discussed below in detail.

Electric power is supplied from a general mains connection, shown as plug 40.

The device has a user interface 160, for example including an operator control panel provided on the apparatus for operation thereof. The user interface may be provided with a display and keys.

The digital image reproduction device may be a printer only, but preferably is a multi-functional device further including scanning, copying or faxing functions, e.g. a versatile copier. A document feeder 110 is provided with an input tray 111 for the introduction of a stack of documents. A transport mechanism (not shown) is provided for transporting the documents one by one along a scanner unit 29 to a tray 112, in which the documents are placed after scanning. The scanner unit 29 includes a flat bed scanner provided with a glass platen on which an original document can be placed, a CCD array and an imaging unit having a movable mirror and lens system for imaging the document on the CCD array. In these conditions, the CCD array generates electrical signals that are converted into digital image data in a manner known per se.

The control unit 12 may be arranged for detecting a scan job in the processing job and executing the scan job by scanning a physical document entered in the input tray 111, and for storing the image file generated during the scanning under the name of the user who activated the processing job. It is noted that the control unit may detect the presence of documents to be scanned and subsequently automatically start a scan job.

The device is arranged for processing the sheets at a nominal processing speed, i.e. the control unit and mechanical elements have been designed for operating at the nominal processing speed continuously (e.g., for large processing jobs), but it can also operate at other speeds. Moreover, the device can change the processing speed while being in operation, in a gradual way. During the continuous operation at any of the possible processing speeds, the sheets are conveyed along the various processing units at a nominal sheet distance, i.e. the sheets enter, and are subsequently transported along, the paper path at regular distances. It is noted that some known devices achieve a reduced throughput speed by omitting sheets at certain predefined instants, usually called a skipping mode. However, in such mode the engine speed, i.e. the transport speed through the conveying system, remains unchanged. Finally, it is noted that, in the nominal speed mode, the sheets are also processed at a nominal document quality, e.g. a selected printing quality. It is noted that some known devices produce prints with a reduced quality at a higher speed. The present invention relates to delivering sheets processed at a predefined, nominal quality level, in spite of varying the document processing speed as discussed below.

For varying the document processing speed, the control unit 12 controls the conveying system and the processing elements to transport and process the sheets at a second processing speed, the second processing speed being different from the nominal processing speed, while the sheets are processed at the nominal sheet distance and the nominal document quality. Moreover, the second speed may be reached in a gradual way. The processing speed may be increased temporarily, e.g. for processing a relatively small job, and may be gradually reduced to the nominal speed during a larger job. In particular, the image reproduction device is arranged for operating at a variable processing speed in a range of processing speeds. Hence, the second speed may take any of a large number of different values. More in particular, the invention includes an implementation in which the processing speed is continuously adapted to the circumstances, within a certain predefined range. At each speed in the range, the documents are processed at the nominal sheet distance and the nominal document quality. Although the present invention is in the first place intended for printing (black only, or color), various other types of processing may be applied to the sheets, such as other surface treatments like applying a cover layer. The processing may also include scanning original sheets, two sided (duplex) treatments, and finishing steps like sorting or stapling.

The elements for document processing are adapted to be operated at the varying speed. Such elements include a digital imaging unit, which is arranged for applying the image pattern based on digital document data at the variable processing speed. Furthermore, the control unit 12 is arranged for selecting the variable processing speed in the range of possible processing speeds in dependence on operational conditions, changing the processing speed in a gradual way and operating the image reproduction device at the variable processing speed as selected. Examples of such operational conditions are discussed below.

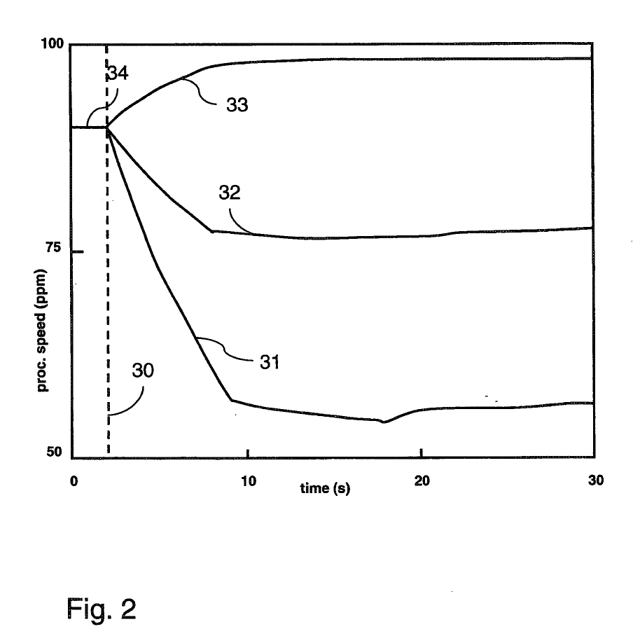

FIG. 2 shows gradually adjusting the processing speed of an exemplary printing engine in response to various operational conditions. The relevant operational conditions are sensed indirectly, by monitoring energy usage, as will be explained in detail below.

In FIG. 2, the processing speed of the engine in pages per minute (ppm) is given along the vertical axis, while the horizontal axis defines time in seconds. A dotted line 30 indicates the start of a printing job. At the start of the job a nominal speed (34) is initially set.

Now, thin paper has a low heat coefficient and therefore, relatively little heat energy is removed from the fusing system, while thick paper takes more energy for fusing toner on it. Accordingly, given a maximum heat production in the fuser, thin paper may be processed at a higher speed than thick paper. The heat production in the fuser may be dictated by the specifications of the constituent parts of the fuser assembly, or may follow from a power consumption limit of the electrical infrastructure.

For example, for curve 33, a relatively thin type of paper sheet (80 g/m²) has been used. The paper type to be processed may be detected by a sensor, or may be known, e.g. from selection of a specific paper input unit. The sheet type may also be detected indirectly, e.g. by detecting a temperature in a temperature controlled processing step like a pre-heater element or fusing element along the paper path. In response to this situation, the control unit decides that a higher processing speed is possible and therefore gradually increases the processing speed until a new equilibrium speed has been reached as is shown in the upper curve 33 of FIG. 2.

A middle curve 32 indicates gradually decreasing the processing speed. A thicker type of paper sheet (120 g/m²) has been used. A lower curve 31 indicates gradually decreasing the processing speed to a substantially lower continuous rate, due to a heavy type of paper sheet (200 g/m²). It is noted that the processing speed is gradually adjusted from the nominal processing speed, at the starting point 30, to the variable processing speed.

Another example of differences in heat capacity of sheets is moisture. Moist paper needs more heat to warm up than dry paper. Yet another example of application of the described effect is adaptation to the environmental temperature. When the temperature is high, the paper sheets need less heating to reach fusing temperature.

According to the invention, the continuously variable processing speed in accordance with the invention can be used to adapt the operation of the device to changes, temporal or continuous, of the mains voltage. In several countries or regions, during periods of excessive loading of the public power net, the mains voltage is lowered. This strategy is known as “brown out.” In such situations, many electrical devices compensate the lower voltage by drawing a higher current in order to maintain their nominal operation, but the maximum current is limited by the fuses in the power network and thus, the effectively available power decreases.

In accordance with one aspect of the present invention, the operation of the device is in real time adapted to the available power, mainly by adjusting the processing speed, since the processing speed dictates the power consumption of most of the sub-units of the device. For instance, when the processing speed is lowered, the fusing system has to heat less sheets per time interval. Additionally, but less important, the motors of the sheet conveying system take less power and even the data processing for providing the print data has a reduced throughput.

In accordance with a principal aspect of the invention, the total electrical current drawn from the mains supply by the device is continuously or at short time intervals monitored. When the mains voltage drops, the effective power delivered to the fuser drops as well, and in compensation, the fuser starts to draw a higher current for maintaining its temperature. The current is allowed to rise, but is limited to a preset maximum current that is somewhat below the maximum allowed value of the power net. The increase in current is detected and when the current reaches the preset maximum value, the control unit 12 starts to gradually reduce the engine speed.

In some situations, the maximum allowed current value of the power net may depend on the time the current is drawn. For example, the maximum allowed current value for short periods may be higher than that for stationary situations. Therefore, the preset maximum current used in the present invention may be a dynamic function of time, higher during an initial operating period and lower thereafter. This would be advantageous for situations where much power is needed, such as warming up from being switched-off or when changing from sleep mode to operational mode. The dynamic function may be programmed into the control system as a step function or a gradually changing function.

If the preset maximum current is not sufficient for the fuser to maintain its operating temperature, the fusing system starts to cool down. Due to its heat capacity and operating margin, the fuser will remain within operating limits for a limited time, until it reaches its lowest acceptable temperature, below which toner is no longer fixed to the image support (paper) sufficiently. At the same time, the decrease in engine speed gradually reduces the heat drain by the fuse process, which would normally increase the temperature. These two effects will compensate each other, and a new equilibrium with a lower processing speed, but still maximum allowed power consumption, will be reached in a relatively short time.

This procedure is also effective for dealing with other situations, such as, e.g., moving a printer device from a place with 20 A wall sockets to one with 10 A sockets. Indeed, a device may be installed at any place, independent of the local mains voltage, since the controller can automatically adapt to the available power rating. In that case, a universal power supply is, of course, necessary, as well as a stored table of voltage/current combinations. In situations where plural combinations of one mains voltage with different current ratings are possible, the user interface could straightforwardly be adapted to ask the operator to enter the current rating.

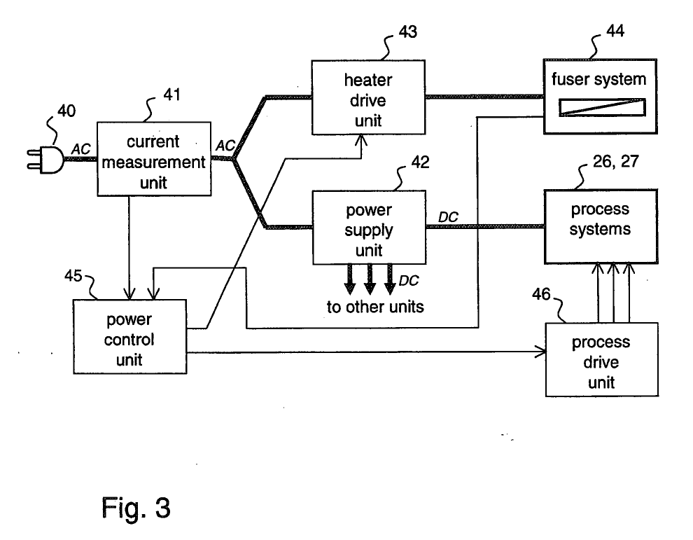

A controller structure and operation for adaptively controlling the processing speed in the above-described embodiment will now be explained with reference to FIGS. 3, 4 and 5.

FIG. 3 shows an example of an energy control system according to the invention. In FIG. 3, thick lines refer to electrical supply lines, whereas thin lines refer to control information connections. In FIG. 3, a connection to the power net is shown as plug 40. The power net is rated at a certain maximum current and secured by a fuse that will blow when the current drawn by the device gets too high. The system further comprises a current measurement unit 41 (known per se) connected to the mains supply 40 at its input side and to a power supply unit 42 and a heater drive unit 43 at its output side. The power supply unit 42 is connected to all systems of the device, including a process drive unit 46, but excluding the fuser system 44, for delivering electrical power thereto.

The heater drive unit 43 is further connected to the heaters of the fuser system 44 (item 26-2 in FIG. 1) for regulating the fuser temperature by regulating the current, e.g. by phase cutting. The process drive unit 46 is for regulating the speed of the printing system 26 and document conveying system 27.

A power control unit 45 is connected to the current measurement unit 41 and to the fuser system 44 for receiving current measurement signals and the fuser temperature, respectively, therefrom. The control unit 45 is further connected to the heater drive unit 43 and the process drive unit 46 for sending control signals thereto. The units 45, 43 and 46 are accommodated in the control unit 12 in FIG. 1, and it is to be understood that they may be implemented as physical units or as computer processes.

In an alternative implementation, the power supply unit 42 may also deliver electrical power to the heater drive unit 43, all other details being the same as above. This is a more expensive, but more flexible construction. The power supply unit 42 may be a universal power supply unit. In that way, the heaters may be powered by DC from the power supply and operate independent of the mains voltage.

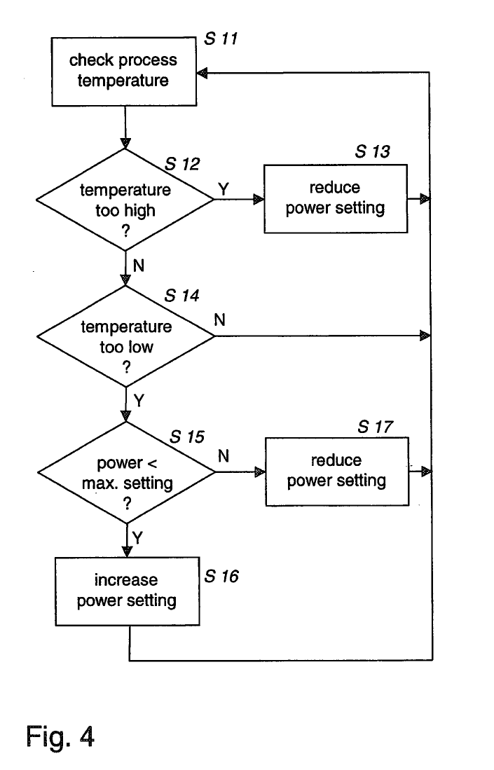

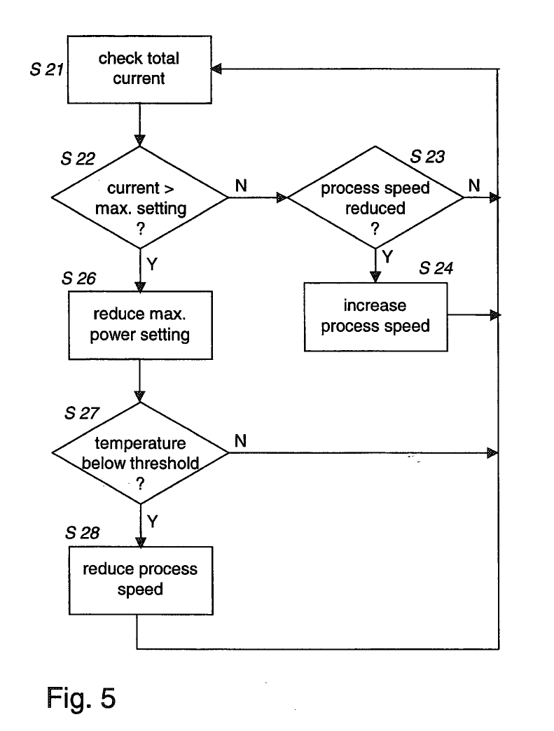

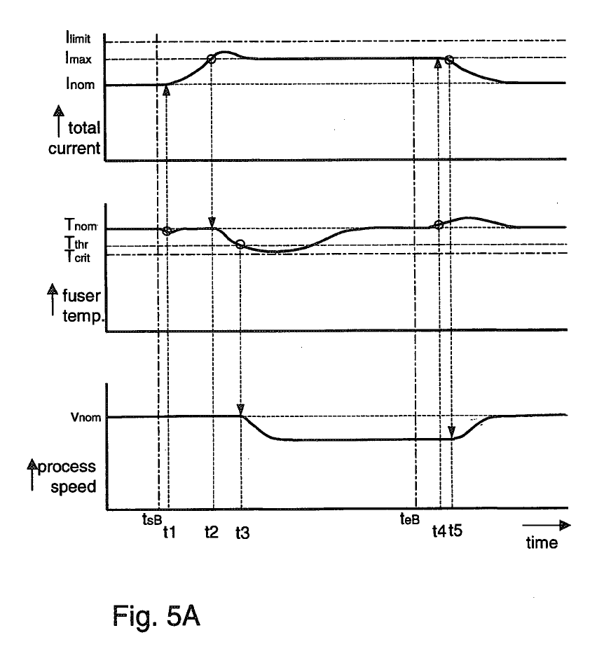

In operation, the heater drive unit 43 powers the fuser heaters in accordance with a power (current) setting received from the power control unit 45. When the fuser cools down in process, or when the supply power drops, the power control unit 45 automatically increases the power setting for the heater drive unit, while limiting the current to a safe value Iₗᵢₘᵢₜ so as not to blow the mains fuse, as explained below with reference to FIG. 4. The power control unit 45 receives the measured current value from the current measurement unit 41, and in accordance with a pre-programmed procedure as explained below with reference to FIG. 5, sends control signals to the process drive unit, specifying a speed setting.

FIG. 4 shows the control process for the fuser temperature as performed by the power control unit 45. Initially, a preprogrammed maximum current setting Iₘₐₓ is assumed, which is lower than the safe current value Iₗᵢₘᵢₜ. In step S1 , the power control unit 45 reads the fuser temperature Tf and in S12 checks it against a nominal value Tₙₒₘ. Tₙₒₘ may be a temperature range in order to prevent frequent switchings. If Tf>Tₙₒₘ (Tf too high), the current supplied to the fuser heaters is decreased (S13) and control loops back to S11. If the Tf is not too high, a check is made (S14) if Tf<Tₙₒₘ (too low) and if it is not, control goes back to S11 without action. If Tf was too low in S14, then it is checked in S15, if the power currently supplied to the heaters is below a maximum power setting Pₘₐₓ. Pₘₐₓ is a preprogrammed value that may be reprogrammed in the control loop explained with reference to FIG. 5. If the power is indeed below the maximum power setting Pₘₐₓ, the power supply setting is increased (S16), whereupon control goes back to S11, but if the currently supplied power is at or above the maximum value Pₘₐₓ, the power supplied to the fuser heaters is decreased (S17) and the control loops back to S11. If, in the latter case, the fuser cools down, it will still remain effective until the fuser temperature reaches its lowest acceptable temperature T_{crit}. Below T_{crit}, the toner will no longer be fixed to the image support (paper sheet) adequately. However, the power control unit 45 has in the meantime brought the process speed down as will now be described with reference to FIG. 5, such that the lowest acceptable temperature will never be reached.

FIG. 5 shows a flow chart of the energy control program that runs in the power control unit 45 in parallel with the fuser temperature process described above. It refers to a stationary situation wherein the device is running normally.

In step S21, control unit 43 checks the current that is drawn from the mains outlet as measured and reported by the current measurement unit 41 against a preset maximum current Iₘₐₓ, which may be constant or a function of time as explained above. If the current is lower than or equal to the maximum current Iₘₐₓ (S22), then it is checked if the process speed is lower than the nominal value (S23). If so, the speed is increased (S24) by a preset amount and the flow returns to a new current measurement S21. If the process speed was nominal in S23, nothing is changed and the flow returns to the current measurement in S21. Instead of a single value for the preset maximum current, also a current range may be used. This would bring some kind of hysteresis in the control process, such that too frequent switchings can be prevented.

If the current was larger than the preset maximum value Iₘₐₓ in S22, then the maximum power setting Pₘₐₓ for the fuser temperature control loop (FIG. 4) is reduced by a predetermined amount, with possible consequences for the fuser temperature. Next, the fuser temperature is checked in S27, and if it is below a predetermined threshold value Tₜₕᵣ (a preset value above the lowest acceptable value), a signal to reduce the process speed is sent to the process drive unit 46 (S28), and the loop returns to step S21, to possibly reduce the processing speed further. Upon receiving a command to reduce the processing speed, the process drive unit 46 gradually reduces the same by a predetermined amount. If the fuser temperature was not below the threshold value Tₜₕᵣ in step S27, then control returns to step S21.

In a simpler construction, the check on the fuser temperature (S27) may be omitted, to proceed to a process speed reduction immediately or possibly after a certain waiting time. Of course, the time constant of that waiting loop should be designed to fit the cooling down characteristic of the fuser system.

Going back to FIG. 5, the process speed reduction in the loop S27, S28, S21, as well as the process speed increase in the loop S23, S24, S21, can be set on a time scale by setting the frequency wherein the loops are run through and by setting the amount of change in step S28 or S24, respectively. The loops do not necessarily have the same time constant. Since the decreasing of the processing speed must be fast enough to prevent the fuser system from cooling down too much, this process should be rather fast, for example a few seconds. The increase in processing speed has lower priority, and may therefore take some more time. Of course, the reaction time of the control process of the process speed also depends on the possibilities of the mechanics of the process and conveyance systems of the printer. Depending on the design of the various parts of the printer, longer or shorter reaction times may be chosen.

FIG. 5A shows a chart of the values of the process variables current, fuser temperature and process speed on a time scale, resulting from the operation of the control process of FIGS. 4 and 5. In FIG. 5A, control events are indicated by a circle, and a resulting effect of the control event is indicated by an arrow running from the associated control event.

For this example, the preset maximum current setting Iₘₐₓ is taken to be constant in time.

Initially, all variables start at their nominal values referring to a normal running situation. Then, at a moment tsB (start of Brown-out), the mains voltage is lowered, and as a result the fuser temperature sinks a little below its nominal value Tₙₒₘ. This is detected at time t1 and is compensated for by a power increase, until the power reaches (at time t2) the preset maximum value Pₘₐₓ related to the maximum current setting Iₘₐₓ, after which power is not further increased, but the current may still have a little overshoot.

The fuser system now starts to cool down, and when it reaches its threshold temperature Tₜₕᵣ at t3, the control unit 12 sets a lower process speed, which is gone to gradually. As a result of the lower speed, the temperature begins to rise again and comes back to its nominal value Tₙₒₘ. The current remains at its elevated level Iₘₐₓ.

When the mains voltage is again restored to its normal value at TeB (T end of Brown-out), first, the fuser temperature will begin to rise, since the increased mains voltage increases the available power. The temperature rise is detected at t4. Accordingly, the power is decreased, whereupon the current starts to drop. This is detected by the power control unit 12, which increases the process speed setting at t5. Then all process variables are gradually restored to their nominal values.

With the above-described control process, the printer will always operate at or slightly below the nominal process speed, unless the mains power net cannot deliver enough energy. In that case, the process speed is automatically reduced to the highest possible value given the mains voltage. This is advantageous when, e.g., heavy weight paper sheets must be processed. Such sheets require quite a lot of heat to be fused properly, such that the power consumption of the device rises and may exceed the rating of the mains connection. Also, when the mains voltage fluctuates within the control space of the process speed, the process speed will automatically follow it, down, as well as up.

Assuming that the device can operate at a process speed that is higher than the power net will support, then if the nominal process speed against which the momentary process speed is checked (in step S23), is set at the device maximum process speed, the device will automatically proceed to the highest speed that the power net (or the device characteristics) would allow, and remain operating at or closely below that value.

In the way described above, the power control unit always takes maximal advantage of the mains supply, while limiting power consumption to a safe value.

In an embodiment, where the device has a scanner unit 29, the control unit 12 is arranged for executing a scan job at a scan speed in dependence of the variable processing speed. In general, the scanning speed may be independent of the processing speed. However, the scanning speed may be adjusted to match the processing speed, e.g. for reducing the noise level produced or adapting the power consumption.

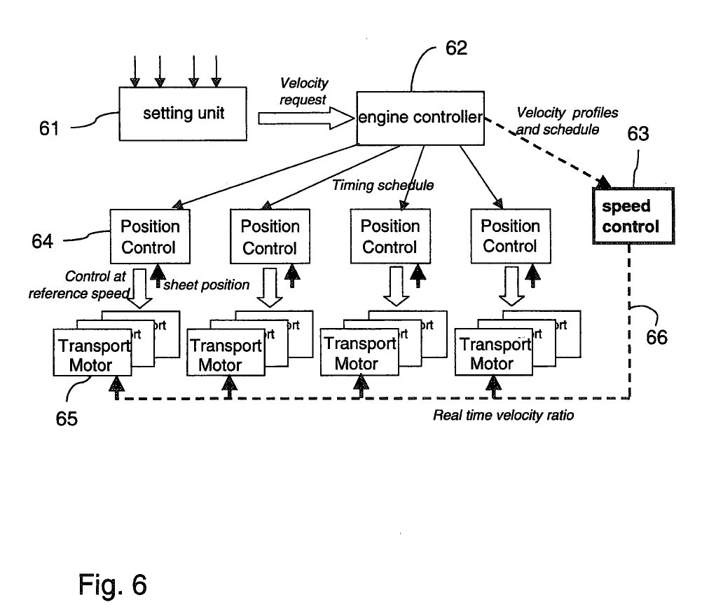

FIG. 6 shows a control structure for a digital image reproduction device, that enables gradual process speed variations in accordance with the present invention.

In FIG. 6, an engine controller 62, which forms part of the control unit 12, controls the actions and allocates the actions to various position control units 64 according to commands providing a timing schedule. The engine controller is based on a controller disclosed in U.S. Pat. No. 6,633,990 of Océ-Technologies B.V., which is incorporated herein by reference.

The position control units 64 each control one or more elements 65 in the processing device, such as transport motors, imaging units, heaters, etc. Each position control unit 64 has local control over a part of the total processing path, e.g. part of the conveying system constituting a part of the paper path. A number of measurements is received at setting unit 61, which may further include a calculation unit for performing algorithms to derive required information about operations conditions and parameters of the sheet processing. According to the operations parameters, a speed request is transferred to the engine controller 62, which communicates velocity profiles and schedules to the position control units 64 and to a speed control unit 63, which sets a speed for each element 65, e.g. a ratio with respect to a reference speed of the respective element, as will be explained below.

With reference to FIG. 3, the process drive unit 46 includes both the setting unit 61 and the engine controller 62 of FIG. 6.

An example of a variable speed control according to the present invention will now be described.

The velocity at which sheets pass the marking area for generating the image is continuously variable. The speed set point and changes are planned in setting unit 61 based on algorithms, which may be driven by measurements like energy consumption, job status, print quality, multi-user behavior, etc. Evaluation of these measurements results in a speed variation, which is then planned and executed via engine controller 62 and speed control unit 63. The engine controller 62 is responsible for planning the transport of each sheet and image through the copier/printer. The planning process results in ‘feed forward’ time targets (as disclosed in detail in the above-mentioned U.S. Pat. No. 6,633,990) which are executed in real-time by distributed position control units 64, called position control. Since sheet position is measured, the position control software is independent of the base speed. The distributed position control units 64 control the transport motors assuming a reference speed. The speed modulation is planned by the engine controller 62 and executed by the speed control unit 63, which executes the velocity profiles by invoking a speed ratio (with respect to the reference speed) directly in real-time to the transport motors in the system.

It is noted that the engine controller 62 may be implemented as a distributed system to support modularity, or may include the speed control unit 63 and/or the setting unit 61. Furthermore, the speed control unit 63 also controls the speed of writing of image lines by a digital imaging unit, in addition to controlling the transport motors. Real-time low level manipulation of motor speed differs in implementation for different motor types, e.g. ‘stepper motors’ require step manipulation, while other motors require set point manipulation.

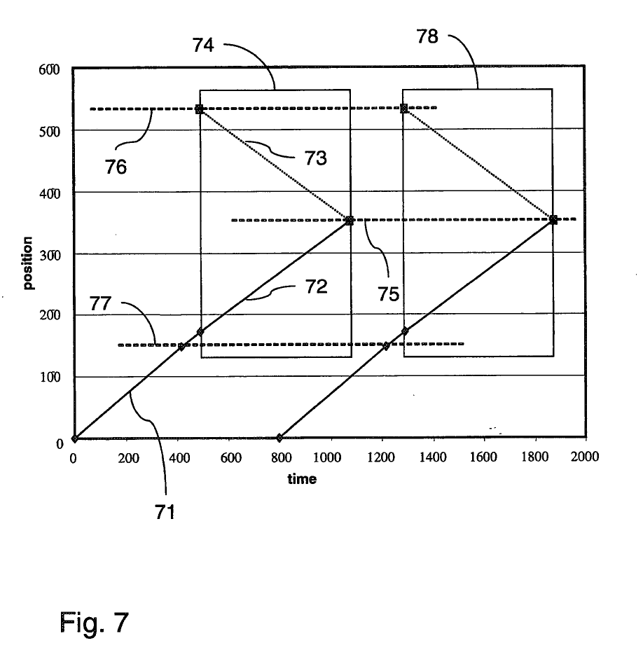

FIG. 7 shows a position and time diagram for a sheet and an image pattern. As is well-known in the printing art, a toner image may be formed in the image forming system 26 under digital control, and then transferred and fused onto an image carrier sheet that has been supplied from sheet input unit 22. Thus, the timings of the sheet input and the image formation must be coordinated accurately. The example of FIG. 7 is given for a simple case in which no speed change is implemented.

The vertical axis in FIG. 7 indicates position, and the horizontal axis indicates time, both in arbitrary units. In the Figure, line 71 indicates the trajectory of a first sheet from a stopper pinch position at coordinates (0;0), via a fine positioning location (X-fine) indicated by a first horizontal dashed line 77, to a fuse position (where the toner image and the image carrier sheet are united), indicated by a second horizontal dashed line 75. A second line 73 indicates the trajectory of a first image pattern from a start of picture (SOP) position indicated by a third horizontal dashed line 76, to the fuse position on line 75. In the Figure, the area in which the second line 73 of the image pattern, and a part 72 of the sheet trajectory, proceed to the fuse position, indicated by rectangle 74, indicates an area of control where the sheet and the image pattern are controlled by one control device, e.g. one same motor. A next rectangle indicates a second sheet and image pattern arriving at the fuse position. In the rectangles, also during speed changes, the profiles of movement along the trajectories are coordinated, and therefore the processed sheet or the image will not be damaged due to speed mismatch. As will be understood, accurate scheduling of control timing, in particular determining synchronization signals, is required during speed changes.

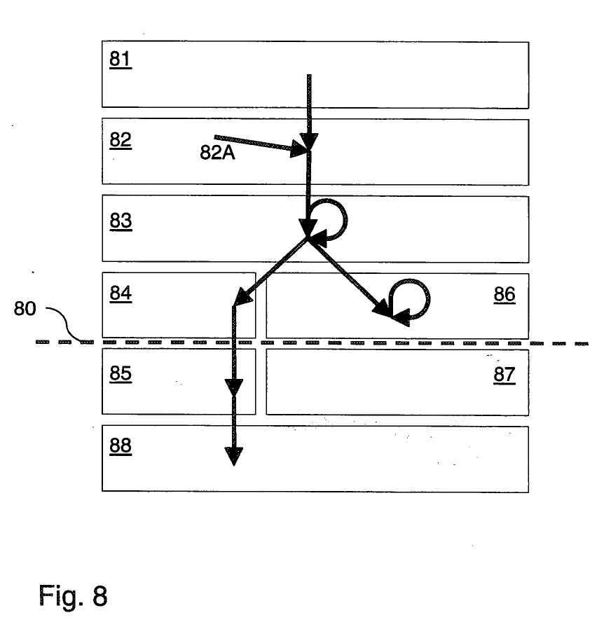

FIG. 8 shows an exemplary process for adjusting the processing speed. The steps above dashed line 80 are performed at a main control node (the engine controller 62), whereas the actual speed control, below dashed line 80, is further executed in a distributed set of sub-nodes (the speed control unit 63 and the position control units 64). The first step 81 indicates a controller step where the engine is informed that a speed change is required for an external reason, such as, e.g., start of an interleave job. At the next step 82, a speed setting step plans the speed change moment. This may also be triggered by an internal cause for speed change 82A (like temperature sensor signals). At the next step 83 synchronization times are (re-)calculated, and speed setting commands are generated to inform sub-nodes of the speed changes at control steps 84. Further procedural steps 86 may also receive updated sync times and speed change information. Such further procedural steps may use the updated sync times for recalculating internal schedules and deriving further sync times. Some lower control level steps 87 may be robust to speed changes, whereas other lower control level steps 85 actually take care of the speed change for the motors of the sheet conveying system 88.

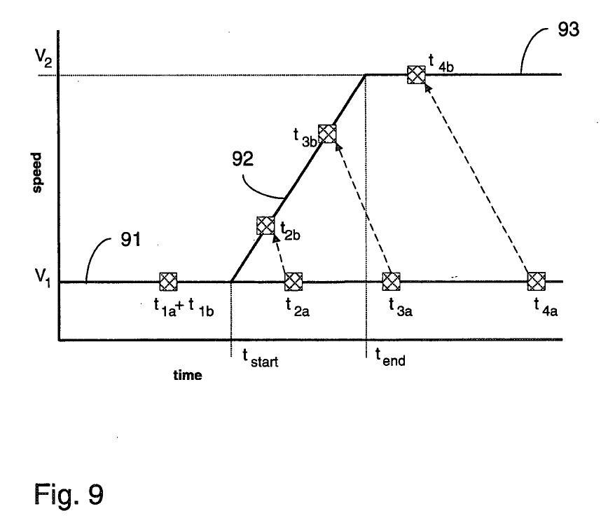

FIG. 9 shows calculation of synchronization times. Synchronization times are times where a coordinated action must take place, such as, e.g., a sheet conveying section taking over a sheet from its preceding sheet conveying section.

In FIG. 9, the vertical axis indicates speed, and the horizontal axis indicates time. In the Figure, a first horizontal line 91 indicates the trajectory of a sheet, which may continue horizontally without speed change as line 94. Four synchronization times are given for the case without speed change (t₁ₐ, t₂ₐ, t₃ₐ, t₄ₐ). Alternatively, in sloping line 92 a speed change is performed from speed V₁ at tₛₜₐᵣₜ to higher speed V₂ at t_{end}, after which the trajectory continues at speed V₂ in line 93. The recalculation of three synchronization times (t_{2b}, t_{3b}, t_{4b}) is illustrated for the case with speed change. FIG. 9 shows a speed profile due to a speed change. From the speed profile, the new synchronization times are calculated based on the position of the respective sheets due to the actual speed.

Although the invention has been mainly explained by large printing devices for a company environment, it is to be noted that the variable speed control is also suitable for document processing on a different scale, such as a small scale printer, multifunction devices or special printing devices like industrial wide format printers. Further, although the invention has been described with reference to a sheet printing device, it is also well suited for printers that print on an “endless” web of paper, that is pulled from a roll and stored on another roll after printing, since the process speed is gradually changed in a real time reaction to power net fluctuations.

It is noted, that in this document the use of the verb ‘comprise’ and its conjugations does not exclude the presence of other elements or steps than those listed and the word ‘a’ or ‘an’ preceding an element does not exclude the presence of a plurality of such elements, that any reference signs do not limit the scope of the claims, that the invention and every unit or means mentioned may be implemented by suitable hardware and/or software and that several ‘means’ or ‘units’ may be represented by the same item. Further, the invention is not limited to the embodiments, and the invention lies in each and every novel feature or combination of features described above.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An image reproduction device for document processing, the device comprising:
a mains power connection that draws electrical power from a power net, said net having a current limitation;
a processing system that applies visible marks on image support material, including a toner fusing system;
a conveying system that conveys the image support material from an input section to the processing system and from the processing system to an output section, the conveying system being adapted to convey the image support material with a continuously variable and dynamically adjustable processing speed;
a current monitor unit that monitors a total electrical current drawn by the device from the mains connection;
a control unit connected to the current monitor unit and arranged to dynamically adjust the processing speed to a lower processing speed value when the total electrical current is above a preset maximum current value, said lower processing speed value being such that the total electrical current drawn by the device from the mains connection is substantially equal to the preset maximum current value.

2. The device according to claim 1, wherein the control unit, when adjusting the processing speed to a lower value, runs through an iterative process of small adjustment steps.

3. The device according to claim 1, wherein the device has a nominal processing speed, and if the total electrical current is below the preset maximum current value and if the actual processing speed is below said nominal processing speed, the control unit dynamically increases the processing speed until the actual processing speed is substantially equal to the nominal processing speed or the actual total electrical current rises above the preset maximum current value.

4. The device according to claim 1, wherein if the total electrical current is below the preset maximum current value, the processing speed is dynamically increased until the actual total electrical current rises above the preset maximum current value.

5. The device according to claim 1, wherein the control unit is arranged to gradually adjust the processing speed.

6. The device according to claim 1, wherein the preset maximum current value is a current value range.

7. The device according to claim 1, wherein the preset maximum current value is a pre-programmed function of time.

8. The device according to claim 1, wherein the control unit dynamically adjusts the processing speed to a lower value with a preset reaction time that is chosen so as to fit to a cooling down characteristic of the toner fusing system.

9. The device according to claim 1, wherein the control unit dynamically defers the adjusting of the processing speed to a lower value, until the toner fusing system has cooled down to a preset threshold value.

10. A method of controlling an image reproduction device for document processing, the device being powered by a connection to a mains power outlet having a current limitation and including:
a processing system that applies visible marks on image support material, including a toner fusing system; and
a conveying system that conveys the image support material from an input section to the processing system and from the processing system to an output section, the conveying system being adapted to convey the image support material with a continuously variable and dynamically adjustable processing speed, said method comprising the steps of:
presetting a maximum current value;
monitoring a total electrical current drawn by the device from the mains connection; and
dynamically adjusting the processing speed to a lower processing speed value if the total electrical current is above the preset maximum current value, said lower processing speed value being such that the total electrical current drawn by the device from the mains connection is substantially equal to the preset maximum current value.

11. The method according to claim 10, wherein the step of dynamically adjusting the processing speed is an iterative control process.

12. The method according to claim 10, wherein the device has a nominal processing speed, and if the total electrical current is below the preset maximum current value and if the actual processing speed is below said nominal processing speed, the processing speed is dynamically increased until the actual processing speed is substantially equal to the nominal processing speed or the actual total electrical current rises above the preset maximum current value.

13. The method according to claim 10, wherein if the total electrical current is below the preset maximum current value, the processing speed is dynamically increased until the actual total electrical current rises above the preset maximum current value.

14. The method according to claim 10, wherein the processing speed is gradually adjusted.

15. The method according to claim 10, wherein the preset maximum current value is a current value range.

16. The method according to claim 10, wherein the preset maximum current value is a pre-programmed function of time.

17. The method according to claim 10, wherein the step of dynamically adjusting the processing speed to a lower value is performed with a preset reaction time that is chosen so as to fit to a cooling down characteristic of the toner fusing system.

18. The method according to claim 10, wherein the step of dynamically adjusting the processing speed to a lower value is deferred until the toner fusing system has cooled down to a preset threshold value.
